(19) United States
(12) Patent Application Publication
(10) Pub. No.: US 2023/0118645 A1
(43) Pub. Date: Apr. 20, 2023

(54) SYSTEM FOR DEBT COLLECTION

(71) Applicant: TechCollect LLC, Reno, NV (US)

(72) Inventors: Gar Liebler, Rochester, MI (US); Michael Novak, Franklin, MI (US); Jaqueline Galofaro, West Bloomfield, MI (US); Brittany Kelley, Oxford, MI (US); Jonathan Paul Prantner, Orchard Park, NY (US); Jeffery Doak, Novi, MI (US); Catherine Hayes, Ann Arbor, MI (US); Harrison Kane, Ypsilanti, MI (US)

(21) Appl. No.: 17/501,767

(22) Filed: Oct. 14, 2021

(51) Int. Cl. G06Q 50/18; G06Q 40/00

(52) U.S. Cl. CPC G06Q 50/18; G06Q 40/12

(57) ABSTRACT

A method and system are disclosed that provides efficient interventions based on unique collection strategies and the priorities of such interventions. The system also provides the expected time for payment. The interventions are generated on an individual debtor basis to improve the efficiency and success of collecting delinquent debts. A profile is determined for each debtor based on historical data that provides the most efficient collection strategy and the optimal priorities of interventions and the likelihood of the delinquent debtors paying by paying by a predicted time The debt collection strategy is based on data analytics of data from different sources including information about the debtor assets, the debtor's financial profile and the debtor's communication habits. This data is fed into a predictive model that is scalable and is used to generate a web-based report on each individual debtor to provide an improved and more efficient collection strategy for collecting delinquent debts.

### BACKGROUND OF THE INVENTION

### 1. Field of the Invention

The present system relates to a system and a method to determine optimal collection strategies and collection times to collect debts using predictive analytical system that processes various types of data to improve debt collection in a manner that improves the computer efficiency of known collection systems and improves computer processing time and the number of channels for processing debts.

### 2. Description of the Prior Art

Delinquent business accounts can have serious ramifications for all types of businesses by impacting balance sheets and operating capital. For example, nationally there are 27 Million homes in community associations. Based on an average delinquency rate of 8.08%, there are an estimated 2.18 million delinquent accounts for unpaid assessments that require collection action. In a recession, delinquencies are known to double or even triple. The average cost to recover each delinquency is approximately $1,000. In order to collect these debts, various collection strategies are known. These collection strategies normally fall into the category of “one size fits all”, which include phone calls and letters to the debtor. Such collection strategies are relatively inefficient and relatively time consuming since all debtors do not act alike. Some debtors may respond to a letter or phone call and pay delinquent debt. Other debtors may require multiple letters, multiple phone calls or a combination before paying the assessment. Other debtors may not respond at all. The reason for the inefficiency of the “one size fits all” debt collection strategy is that there are several unknowns in such collection strategies. For example, is it better to make calls to the debtor? How often should email be used to contact debtors versus sending letters to the debtors by mail. Other factors must also be considered escalated actions. For example, how much debt justifies legal action.

Prior art debt collection systems are known. For example, U.S. Pat. No. 7,519,553 discloses a method and system for debt collection optimization. The system discloses a data processing system that analyzes past historical data to handle debt collection by formulation of the collections process as a Markov Decision Process by estimating the next action based upon maximizing the payment given the costs and payment history. This method maximizes the next repayment amount while being bounded by cost and customer response, as modeled through a linear regression of variables based on past historical data but unfortunately does not provide the likelihood of settlement nor the expected time for settlement

Thus, there is a need to improve the efficiency collection strategies for collecting delinquent debts.

### SUMMARY OF THE INVENTION

A method and system in accordance with the present invention solves debt collection problems by providing efficient interventions based on unique collection strategies and the timing of such interventions. The system also provides the expected time for payment. The interventions are generated on an individual debtor basis to improve the efficiency and success of collecting delinquent debts. A profile is determined for each debtor based on various data including historical data that provides the most efficient collection strategy and the optimal priorities of interventions and the likelihood of the delinquent debtors paying by a predicted time. The debt collection strategy is based on data analytics of data from different sources including information about the debtor assets, the debtor's financial profile, debtor demographic profile and the debtor's communication habits. This data is fed into a predictive model that is scalable and used to generate a report for each individual debtor including scoring of the above profiles and data points to provide overall score an improved and more efficient collection strategy for collecting delinquent debts.

### DESCRIPTION OF THE DRAWING

These and other advantages of the present invention will be readily understood with reference to the following specification and attached drawing wherein:

FIG. 1 is an exemplary diagram of illustrating exemplary data sources for use with the present invention.

FIG. 2 is an exemplary block diagram of the system.

FIG. 3a is an exemplary report for an individual debtor that that delineates collection strategies for a delinquent assessment and the predicted likelihood to settle the debt and the predicted time to settle.

FIG. 3b is an alternative exemplary report that illustrates an exemplary recovery score of 9.1 based upon interventions such as, proactive outreach+legal action and the predicted time to collect the debt.

FIGS. 3c and 3d provide a breakdown of the interventions in FIG. 3b.

FIG. 3e illustrates predicted recovery scores and the predicted days for various settlement paths based upon individual types of interventions.

FIGS. 4a and 4b illustrate an exemplary set of data points for use with the present invention.

FIG. 5 is a block diagram illustrating the steps in obtaining and pushing the data to the models that form a part of the data analytics.

FIG. 6 is a diagram of an exemplary algorithm for segmenting delinquent debtors into exemplary categories or cohorts.

FIG. 7 is an exemplary diagram of a Markov based transition matrix which illustrates the touchpoints with the highest contribution to provide an optimum path.

FIG. 8 illustrates a list of exemplary channels that can be processed with the present invention.

FIG. 9 is a comparative block diagram illustrating the differences between the present invention and systems based on the Shapely method that improves the efficiency of computer processing.

FIG. 10 is a diagram summarizing the process in accordance with the present invention.

FIG. 11 is an exemplary method of alternative batch file processing in accordance with the present invention.

### DETAILED DESCRIPTION

A method and system are disclosed that solve the problems with known debt collection systems by providing efficient interventions based on various collection strategies and the priorities of such interventions, including scoring the success of such interventions based on the evaluation of the data points obtained. The system also provides the expected time for payment. The interventions are generated on an individual debtor basis to improve the efficiency and success of collecting delinquent debts. A profile is determined for each debtor based on various data including historical data that provides the most efficient collection strategy and scores the data points obtained for that debtor and the optimal priorities of interventions and the likelihood of the delinquent debtors paying represented by a score, as well as the estimated timing of payment. The debt collection strategy is based on data analytics of data from different sources including information about the debtor assets, the debtor's financial profile, debtor demographic profile, and the debtor's communication habits. This data is fed into a predictive model that is scalable and is used to generate a web-based report for each individual debtor to provide an improved and more efficient collection strategy for collecting delinquent debts.

Various embodiments of the method and system are contemplated. In one embodiment, the system is available on an individual debtor basis or on a batch basis. In an individual debtor embodiment, a single report product may be generated for each delinquent debtor based on their address. This report may be available on a web portal that may be searchable by the debtor's address. The report may provide a detailed summary of the data points accessed and evaluated, specific strategies for interventions and the optimal priority for such interventions, and the projected date of recovery. An alternative report may be provided that provides scoring of debtor profiles and data points to provide overall score an improved and more efficient collection strategy for collecting delinquent debts. In alternative embodiment, a method is disclosed for enhancing collection of debts by way of a batch method of multiple debtors.

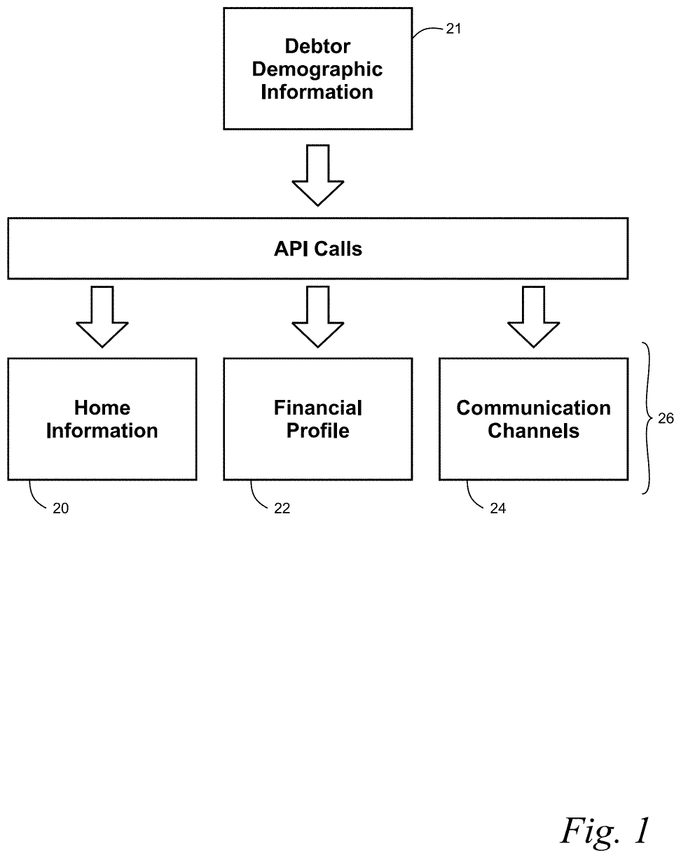

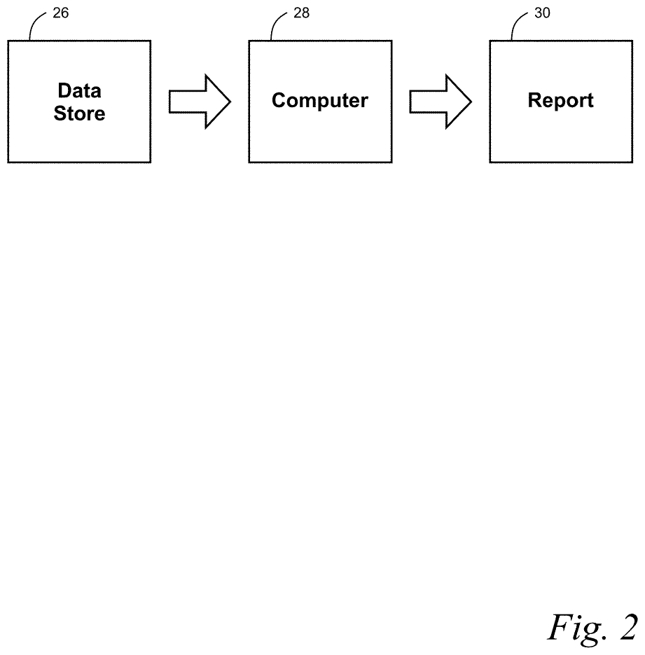

The system is applicable to debt collection in virtually any industry. An example of the system is provided below in an exemplary application, namely collection of debts comprising delinquent homeowner assessment dues in which the homeowners are the debtors. As illustrated in FIG. 1, the system utilizes data available from various data sources. This data may be categorized in three general categories; debtor asset information 20, debtor demographic information 21, debtor financial information 22 and information related to the communication channels used by the debtor 24, stored in a data store 26 (FIG. 2). The debtor asset information 20 may include information regarding the asset value, equity in the asset and the loan balance on the asset. The debtor demographic information 21 may include age, race, education, gender, and marital status. The financial information 22 may include the debtor's income, debt utilization and employment. Information regarding the communication channels 24 may include their response to mail ads, mobile phone number and the number of email addresses maintained by the debtor and social media profiles.

In addition to the above, additional data may be incorporated into the system. This data may fall in four general categories: micro-economic data, macro-economic data, socio-economic data and psychographic data. The micro-economic data may include the amount of the debt and the debtor's employment status. Macro-economic data for delinquent homeowner assessment debts may include real estate values in the vicinity of the homeowner's property and regional employment. Socio-economic data may include the delinquent debtor's spending habits, prior delinquencies, and any bankruptcies.

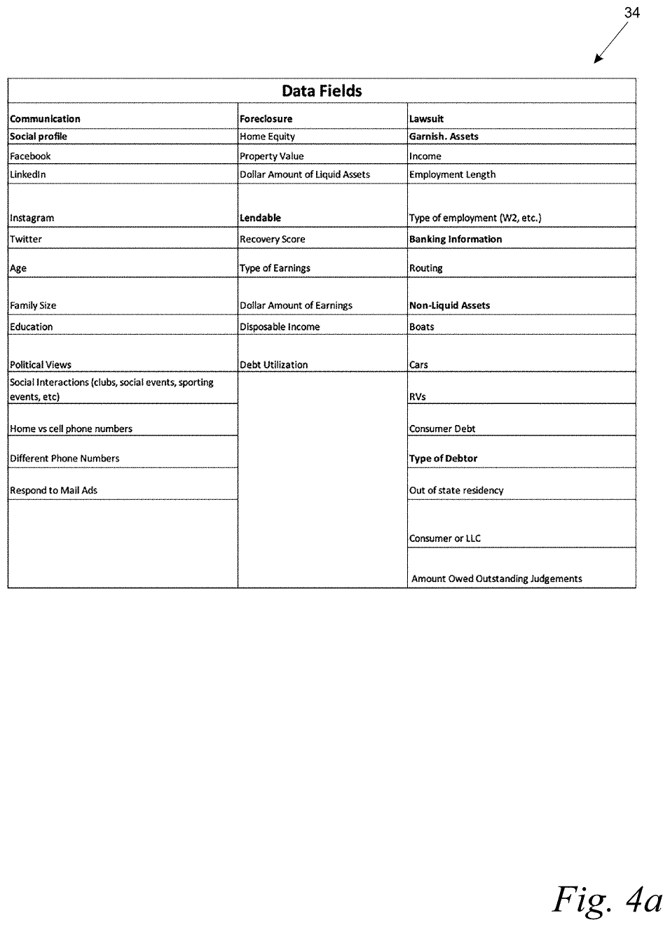

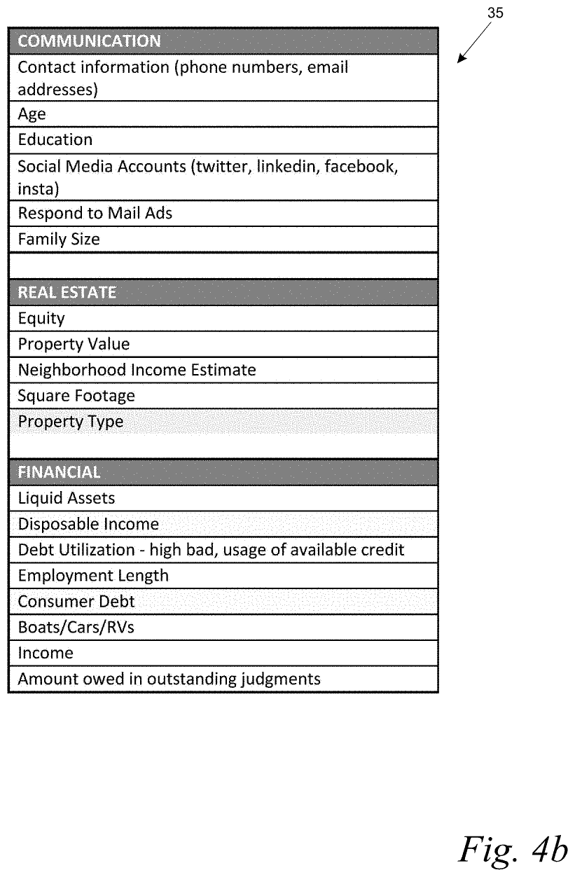

All data is stored in a data store 26 (FIG. 2) and processed by a computing device 28 to generate various types of exemplary reports (30,31 3a and 3b). Data from the data store 26 is used to populate an exemplary a data template 34 (FIG. 4A) or an exemplary data template 35 (FIG. 4B) to process the data and generate the reports 30, 31.

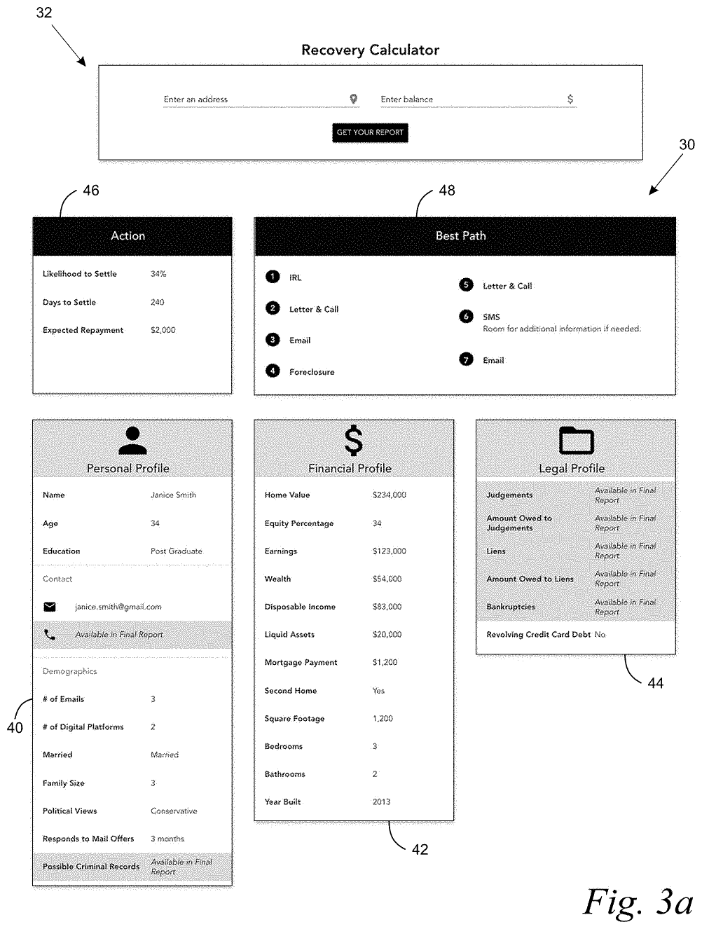

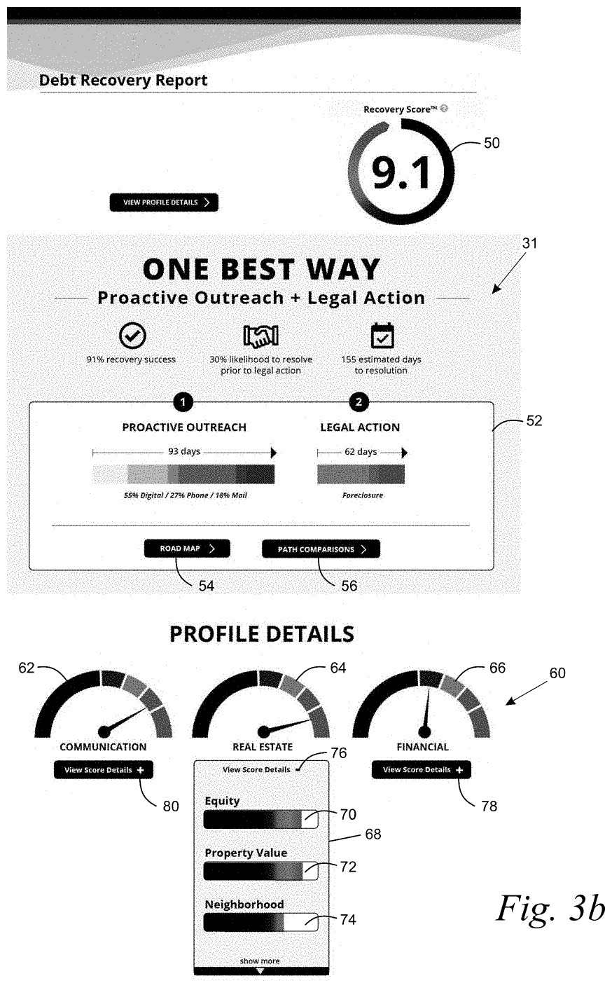

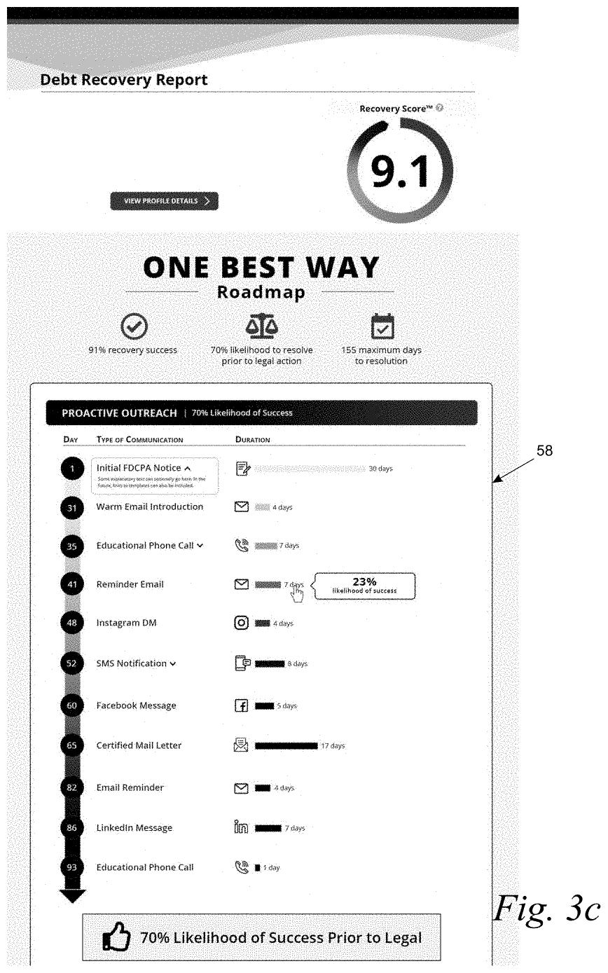

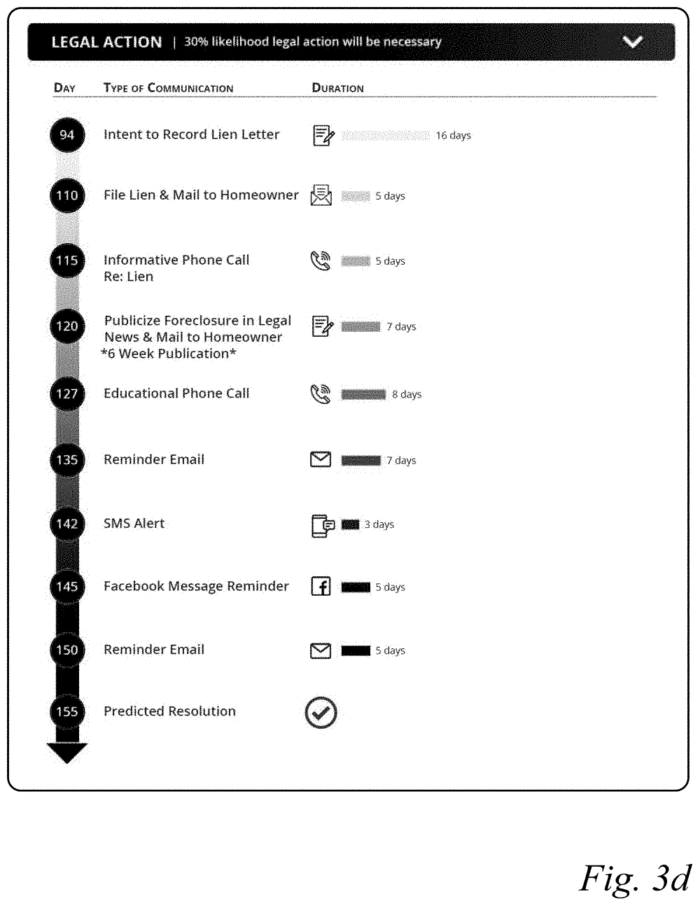

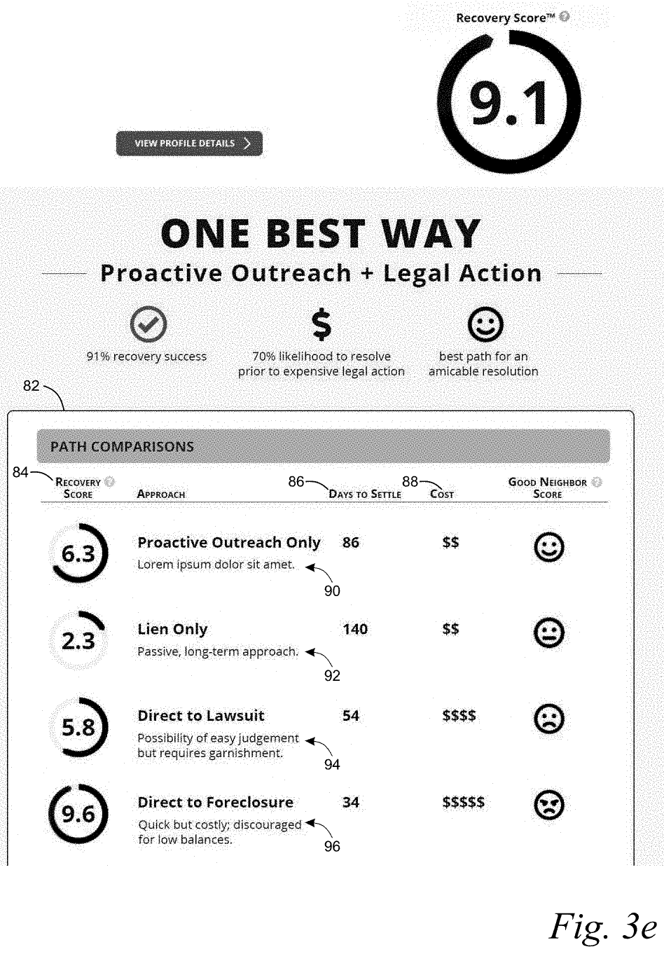

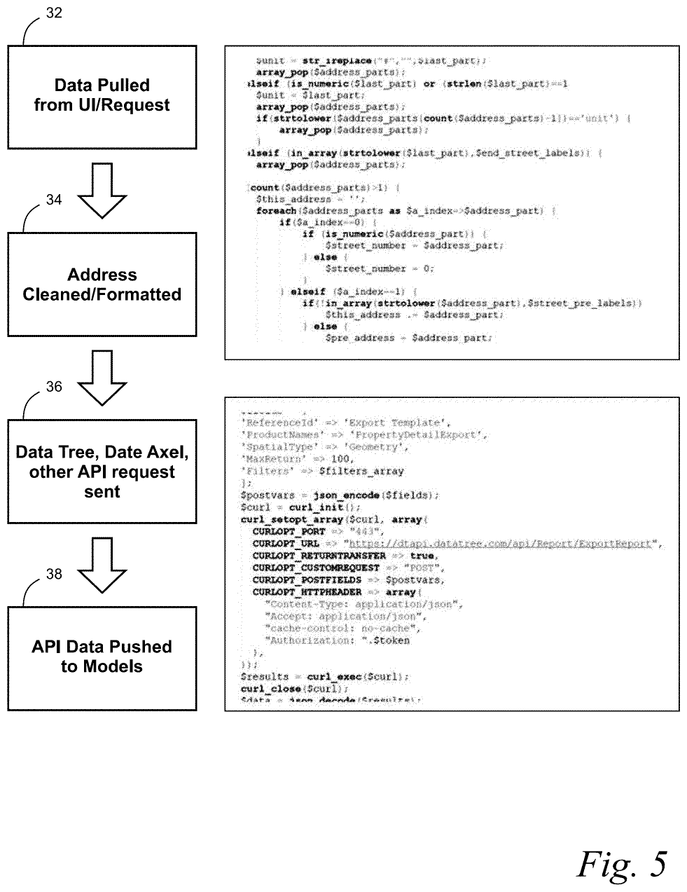

Access to the system may be by an address list for retrieving debtor information, such as selecting a debtor address on a spread sheet from a list of addresses in the homeowner community or other means or by way of a text box 32 (FIG. 3a). The debtor's address may be used to connect to a series of APIs to retrieve a wealth of information about the delinquent debtor from the data store 26. This data is used to create a feature set for machine learning models, discussed below. As illustrated in FIG. 5, data from the data store 26 may need to be pre-processed before being processed by the models discussed below. Once the debtor's address is entered, as indicated in step 32, the debtor's address is cleaned and formatted, in step 34. In the next step 36, data tree, data axle and other requests are generated to configure the machine learning model using software available from PHP, for example. The data is pushed to the models in step 38.

Four general information categories, illustrated in FIG. 1, are extracted from the data store 26 (FIG. 2) from thousands of historic debtor files and combined with propriety communication and payback history to create a feature set for machine learning models. Four separate machine learning models are estimated using an AWS Sagemaker implementation using a Distributed Random Forest (DRF) algorithm to determine. AWS Sagemaker is a machine learning platform, available from Amazon Web Services, that is used to create, train, and deploy machine learning models based on a DRF algorithm. The DRF algorithm is a commonly known powerful classification and regression tool. Given a set of data, the DRF algorithm generates a forest of classification or regression trees, rather than a single classification or regression tree.

Each tree is a weak learner based on a subset of rows and columns. Each tree is constructed using the following algorithm:
Let the number of training cases be N, and the number of variables in the classifier be M.
Choose a training set for this tree by choosing n times with replacement from all N available training cases (i.e. take a bootstrap sample).
Use the rest of the cases to estimate the error of the tree, by predicting their classes.
For each node of the tree, randomly choose m variables on which to base the decision at that node. Calculate the best split based on these m variables in the training set.

For prediction, a new sample is pushed down the tree. This procedure is iterated over all trees in the ensemble and the average vote of all trees is reported as random forest prediction. A random forest is a meta estimator that fits several decision tree classifiers on various sub-samples of the dataset and uses averaging to improve the predictive accuracy and control over-fitting. The sub-sample size is always the same as the original input sample size, but the samples are drawn with replacement. The default values for the parameters controlling the size of the trees (e.g. max_depth, min_samples_leaf, etc.) lead to fully grown and unpruned trees. The features are randomly permuted at each split, where the best-found split may vary, even with the same training data if the improvement of the criterion is identical for several splits enumerated during the search of the best split.

The first model estimates a recovery score for proactive outreach interventions only for debtors whose liabilities have been repaid with communications alone and no legal interventions, based on a feature set as shown in FIG. 4a or FIG. 4b. The model exports a likelihood recovery score for each file's likelihood of repayment.

The second model estimates the time to repayment for debtors using proactive outreach interventions in which liabilities have been repaid with communications alone and no legal interventions based on the feature set. The second model exports a regression-based estimate for each file's repayment date.

The third model estimates a recovery score for debtors whose liabilities have been repaid with proactive outreach communications as well as legal interventions based on the feature set. The third model exports a likelihood score for each file's likelihood of repayment.

The fourth model estimates the time to repayment for debtors whose liabilities have been repaid with proactive outreach communications as well as legal interventions based on the feature, based on the feature set. The fourth model exports a regression-based estimate for each file's repayment date.

These four model artifacts are accessible through an API connection. The API call passes the feature set without any personally identifiable information to AWS Sagemaker and four numbers are returned: likelihood of repayment without legal intervention, time to repayment without legal intervention, likelihood of repayment with legal intervention, time to repayment with legal intervention.

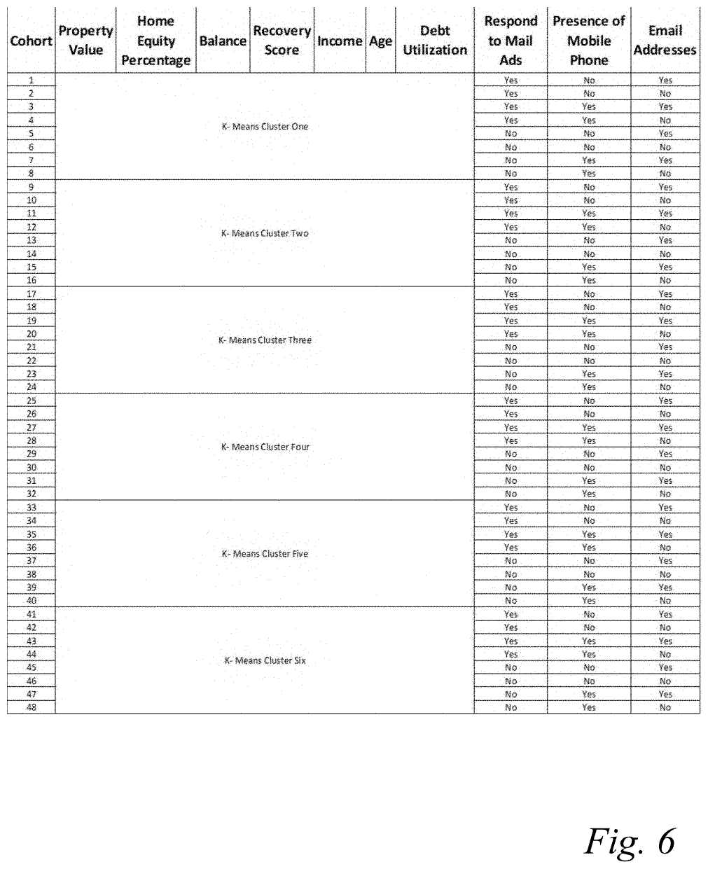

During the model development process, feature importance is extracted from the first random forest model. The features with the highest Gini score are determined, where Gini score is a measure of how each variable contributes to the homogeneity of the nodes and leaves. The Gini coefficient is a measure of homogeneity from 0 (homogeneous) to 1 (heterogeneous). Each time a variable is used to split a node, the Gini coefficient for the child nodes is calculated and compared with the original node. Changes of the Gini coefficients are summed for each variable and normalized at the end of the calculation. Variables that result in nodes with higher purity have a higher decrease in Gini coefficient. These key variables are then used to form a segmentation framework to separate the debtors into an exemplary forty-eight relative categories or cohorts, based on a custom algorithm illustrated in FIG. 6.

Asset value, asset equity percentage, balance, income, age, and debt utilization may be run through an AWS SageMaker implementation of k-means clustering to separate the cohorts into distinct groups, which are then further segmented based upon responses to exemplary data points, for example, as illustrated in FIG. 3c.

K-means clustering is an unsupervised learning algorithm for finding discrete groupings within data, where clusters are internally homogenous and externally heterogenous. K-means is an algorithm that trains a model that groups similar objects together. The k-means algorithm accomplishes this by mapping each observation in the input data set to a point in the n-dimensional space, where n is the number of attributes of the observation. K-means clustering chooses the initial cluster centers from the observations in a small, randomly sampled batch. The cluster centers created are mostly random, with some consideration for the training dataset. In this step, the training dataset is used to move these centers toward the true cluster centers. The algorithm iterates over the training dataset and recalculates the K cluster centers created K clusters-(K=k*x), where x is greater than 1—then it reduces the K clusters to k clusters.

Within each of the 48 individual cohorts, illustrated in FIG. 6, a Markov Removal Model analysis is run to determine the incremental contribution of each consumer touchpoint. The Markov analysis forecasts the value of a variable whose predicted value is only influenced only by its current state not any prior states. S-graph based Markovian framework may be used to analyze customer journeys by adapting an Archak-Mirrokni approach. See generally; “Putting Attribution to Work: A Graph-Based Framework for Attribution Modeling in Managerial Practice”, by Eva Anderl, Ingo Becker, Florian v. Wangenheim and Jan H. Schumann, published Oct. 23, 2013, and “Mining Advertiser-Specific User Behaviors Using Adfactors” by Nikolay Arcchak, Vahab S. Mirrokni, and S. Muthukrishnan, Proceedings of the 19^{th} International Conference on the World Wide Web, 2010, hereby incorporated by reference.

Markov chains are calculated as probabilistic models that represent dependencies between sequences of observations of a debtor's journey. These are created through a Markov graph m={s,W} where s is defined as s={s1, . . . , sn} where each state represents a communication touchpoint or legal intervention in the debtor's path and W is a transition matrix where the edge weights are defined below.

$${w}_{ij} = P ( {X}_{t} = {s}_{j} \vert {X}_{t - 1} = {s}_{i} ) , 0 \leq {w}_{i , j} \leq 1 , {\sum }_{j = 1}^{N} {w}_{ij} = 1 ∀ i .$$

W is the transition weight (probability) given by the equation above, which is the conditional probability of success in the current state given the non-conversion value in the prior state. Conditional probability is defined as the joint probability of event A and B divided by the probability of A. In this case that means the probability of success in each step where the prior step was not a success divided by the probability that the prior step as not a success. The relative probabilities of repayment at each debtor state are maximized in order to find the optimal path to maximize conversion including both the order and frequency of each touchpoint.

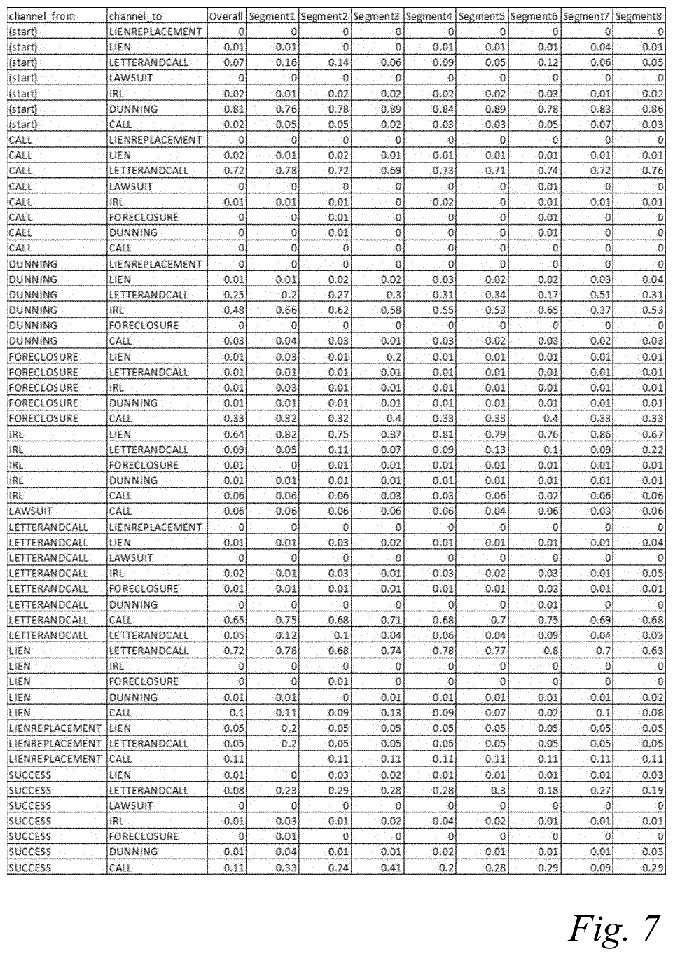

Based upon the transition matrix for the cohort, the touchpoints with the highest contribution (FIG. 7) are selected to provide an optimal path, the information retrieved from APIs (FIG. 4), the results of the likelihood to repay model (FIG. 6), the cohorts developed by Markov analysis, as discussed above, and the best path (FIG. 7) are returned to the creditor representative in the webpage report (FIGS. 3a, 3b). Within each individual cohort, a Markov analysis is run to determine the incremental contribution of each consumer touchpoint (FIG. 7).

The system may generate alternative exemplary reports 30, 31 (FIGS. 3a, 3b-3e) that provide optimal collection strategies based on interventions and provides the priority timing of the interventions. These reports provide scoring of debtor profiles and data points to provide an overall score and an improved and more efficient collection strategy for collecting delinquent debts.

The system provides collection strategies and recovery scores and the optimal timing of interventions of the debtor. The timing is provided in the estimate time to the state paid in full without intervention and with intervention. These paths indicate the order and sequence of the steps and the time element for each step, driven based on historic timing per channel integrated with the expected time to repayment.

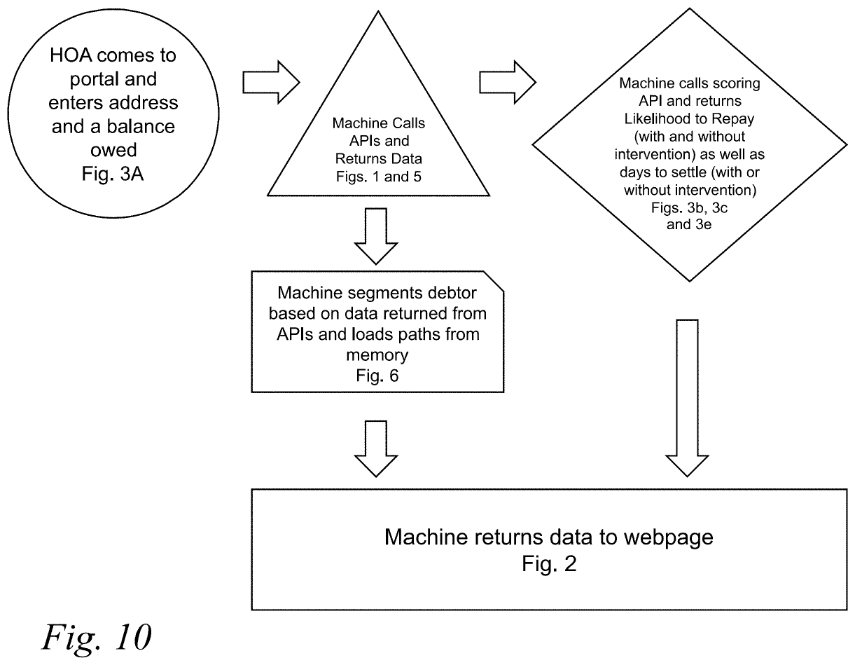

A simplified data flow of the process is discussed below and illustrated in FIG. 10.
User enters address and balance (via webpage or batch upload)
Additional data is collected via APIs
Transfers data to API for scoring for four separate models.
1. Likelihood of repayment without legal intervention
   i. In building model
      1. A subset of data is taken
      2. A subset of variables is taken
      3. Tree is built
         a. Data is split to maximize the difference between paid and unpaid om first variable
         b. Process repeated for each variable
      4. 500 trees are built
   ii. In scoring model data is run through all 500 trees
   iii. Average expectation from each tree is returned
2. Time repayment without legal intervention
   iv. Same Process as Above
3. Likelihood of repayment with legal intervention
   v. Same Process as Above
4. Time of repayment with legal intervention
   vi. Same Process as Above
Based upon variables most seen in the 500 trees the program selects the optimal variables for repayment
Consumers are segmented based on the importance of variables in the last step
Given a set number of clusters (twelve) the variables from the prior step are used to group the customers into twelve groups
   vii. Each group is selected so that the average difference between the groups is as great as possible across the important variables as well as that the variance within each group is as small as possible within the groups

For each segment, the optimal path is computed
Building the model
   viii. Examine each consumer and their communications in order
   ix. Group consumers by the order and frequency of their communications and interventions
   x. Count the payments and non-payments for each communication group
   xi. Compute the conversion rates and use this to determine the impact of each communication/intervention
   xii. Output a matrix that shows the value of each step
   xiii. Find the maximum value to determine which step to use
      1. Reduce the value of each combination that has been previously used
      2. Repeat out to the steps to create a communication plan
Scoring the data
   xiv. The segment from the prior step is used to select the optimal model where each step
Data, scores, segments and paths are displayed in the report to the end user

An exemplary report 30, for example, as illustrated in FIG. 3a, may be generated for each debtor. The report 30 may contain, a personal profile 40, a financial profile 42 and a legal profile 44. The personal profile 40 contains the debtor's name and various demographic information. The financial profile 42 includes the debtor's asset, the equity percentage in the asset, the debtor's earnings and various other financial information. The legal profile 44 includes judgements against the debtor, liens, bankruptcies and other information. The data for these profiles 40, 42 and 44 is generated from the debtor data template 34 (FIG. 4).

An exemplary alternative report 31 may be generated, as illustrated in FIG. 3b. Various scores may be determined from the raw data produced from the four models, discussed above, based upon one or more interventions. These scores are quantified and range from 1 to 10 and include a Proactive Outreach Only Score, a Lien-Only Score, a Direct-to-Foreclosure Score, and a Direct-to-Lawsuit Score. One or more of these scores may be combined to arrive at a Recovery Score, which provides the optimal collection strategies, i.e., interventions, for collecting delinquent debts. Each of these scores is discussed below.

### Recovery Score

The Recovery Score is a score based upon one or more interventions associated with payment of the debt. An exemplary Recovery Score is illustrated in FIG. 3b. In this example, the Recovery Score is based upon Positive Outreach interventions+Legal Action interventions, as determined by the models discussed above. “Positive Outreach” may include one or more of the proactive outreach interventions as illustrated in FIG. 3c and one or more legal interventions may include filing a lien, filing a lawsuit directly, or filing a foreclosure action directly, as illustrated in FIG. 3d.

The box 52 may include a “road map” button 54 and a path comparison button 56. Path comparisons are illustrated in FIG. 3e. The road map button 54 illustrates another tier of the report 31 based on proactive interventions+legal interventions, as illustrated in FIGS. 3c and 3d. Profile details of the debtor are illustrated and generally identified by the reference numeral 60. As shown, the debtor profile 60 may be illustrated in terms of gas gauges 62, 64 and 66 for various categories of information, such as communication information, real estate information and financial information, that is derived from the data store 26 (FIG. 2).

With respect to the real estate 76, it may be broken down as illustrated in the box 68 by way of bar graphs in terms of equity in the real estate 70, property value 72 and the neighborhood 74. selectable by way of a button 76. The buttons 78 and 80 may be selected to provide additional information on the communication category 80 and financial category 78.

FIG. 3b illustrates an exemplary debt recovery report. This report is based upon proactive outreach+legal interventions. As shown, the time to settle a debt is illustrated as 155 days. The 155 days is based upon 93 days of proactive outreach interventions+62 days of legal interventions. FIG. 3c illustrates the exemplary proactive interventions and the time for each intervention for a total of 93 days. FIG. 3d illustrates various exemplary legal interventions for a total of 62 days. The proactive outreach interventions+the legal interventions (93+62) add up to 155 days to recovery, as illustrated in FIG. 3b.

FIG. 3e may be used to provide an additional tier of the report 31, as illustrated in the box 82 to compare intervention path comparisons. Various categories of interventions are compared by recovery score 84, days to settle 86, and comparative costs 88. In this example, four different intervention categories are compared; proactive outreach only 90, lien only 92, direct to lawsuit 94 and direct to foreclosure 96. As shown, the proactive outreach 90 is the best choice in this example with the shortest number of days to settle and one of the lowest costs to recover.

After the Recovery Score is determined, it may be modified with an exemplary Lambda Function as set forth below. In particular, if the debtor's home equity percentage is greater than 90% and the Recovery Score is less than 2.0, the Recovery Score will increase by 8 points. If the home equity percentage is greater than 90% and the Recovery Score is less than 3.0, the Recovery Score will increase by 7 points. If the home equity percentage is greater than 90%, and the Recovery Score is less than 4.0, the Recovery Score will increase by 6 points. If the home equity percentage is greater than 90% and the Recovery Score is less than 5.0, the Recovery Score will increase by 5 points. If the home equity percentage is greater than 90% and the Recovery Score is less than 6.0, the Recovery Score will increase by 3.5 points.

There is a similar set of rules for debtors whose home equity % between 80%-90%. If the home equity percentage is between 80%-90% and the Recovery Score is less than 2.0, the Recovery Score will increase by 7 points. If the debtor's home equity percentage is between 80%-90% and the Recovery Score is less than 3.0, the Recovery Score will increase by 6 points. If the debtor's home equity percentage is between 80%-90% and the Recovery Score is less than 4.0, the Recovery Score will increase by 5 points. If the debtor's home equity percentage is between 80%-90% and the Recovery Score is less than 5.0, the Recovery Score will increase by 4 points.

### Proactive Outreach Only Score

The Proactive Outreach score is the score with one or more interventions, for example, as illustrated in FIGS. 3C and 3D. If the Proactive Outreach Only Score is the same as the Recovery Score, the Proactive Outreach Only Score is multiplied by a randomly generated factor between 0.75 and 0.05, and the Recovery Score retains its original value.

### Lien Only Score

The Lien-Only Score is the score is based upon a single legal intervention of filing a lien against the property for the debt. If the lien only score is less than the Recovery Score and greater than the Proactive Outreach Only Score, then the Lien-Only Score is assigned the difference between the Lien-Only Score and the Proactive Outreach Only Score. Otherwise, if the Lien-Only Score is less than the Recovery Score, and the Lien-Only Score is also less than the Proactive Only Score, then the Lien-Only Score remains the same. Otherwise, if the Lien-Only Score is less than the Recovery Score and the Lien-Only Score equals the Proactive Outreach Only Score, then the Lien-Only Score is assigned a value of the Lien-Only Score multiplied by a factor of randomly generated between 0.65 and 0.05.

### Direct-to-Foreclosure Score

The Direct to Foreclosure Score is based upon a single intervention of directly filing a legal foreclosure against the property. If the Direct-to-Foreclosure Score is less than the Recovery Score and the direct foreclosure is greater than the Proactive Outreach Only Score, then the Direct Foreclosure Score is assigned the value of the Direct-to-Foreclosure Score minus the Proactive Outreach Only Score. Otherwise, if the foreclosure score is less than the Recovery Score and the direct foreclosures score is also less than the Proactive Outreach Only Score, the Direct-to-Foreclosure Score remains unchanged. Otherwise, if the Direct-to-Foreclosure Score is less than the Recovery Score, and the Direct-to-Foreclosure Score is equal to the Proactive Outreach Only Score, then the Direct-to-Foreclosure Score is assigned the value of the Direct-to-Foreclosure Score multiplied by a randomly generated factor between 0.75 and 0.05. Lastly if the Direct-to-Foreclosure Score is equal to the Recovery Score, then the Direct-to-Foreclosure Score is assigned a value of the Direct-to-Foreclosure Score multiplied by a randomly generated factor between 0.75 and 0.05.

### Direct-to-Lawsuit Score

If the Direct to Lawsuit score is less than the Recovery Score, and the Direct to lawsuit score is a sign the value of the Direct to Lawsuit score minus the Proactive Outreach Only Score.

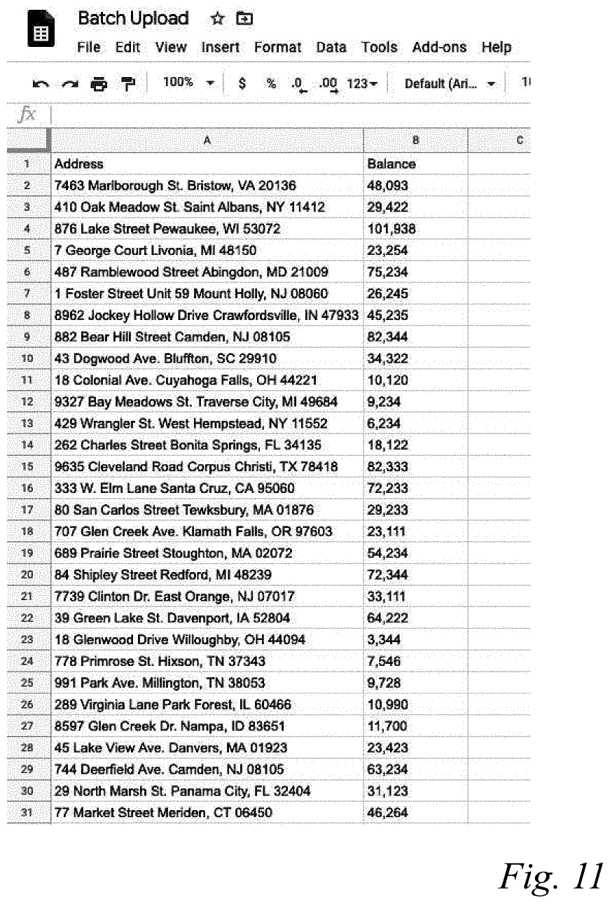

The second method of addressing debtors is through batch fie processing. In this method, the user uploads a list of address and the amounts owed as a csv file, as shown in FIG. 11. The file is connected to a series of APIs (FIG. 5) which retrieves a wealth of information about the debt holder, shown in FIG. 4. That information is then sent to an API for scoring against a custom developed model, as illustrated in FIG. 6 to score consumers based upon their likelihood to repay and the predicted time for repayment. Based upon the custom model, a custom segmentation framework is developed and groups customers into separate cohorts by way of Markov analysis, discussed above.

### Improvement in Computer Processing

The present invention utilizes a Markov Removal Model to process debt collection data. As discussed below, the Markov Removal Model results in a reduction in computer processing time and an increase in the number of channels that can be processed for predicting repayment of debts relative to an industry standard of utilizing a Shapley attribution, commonly used for collections.

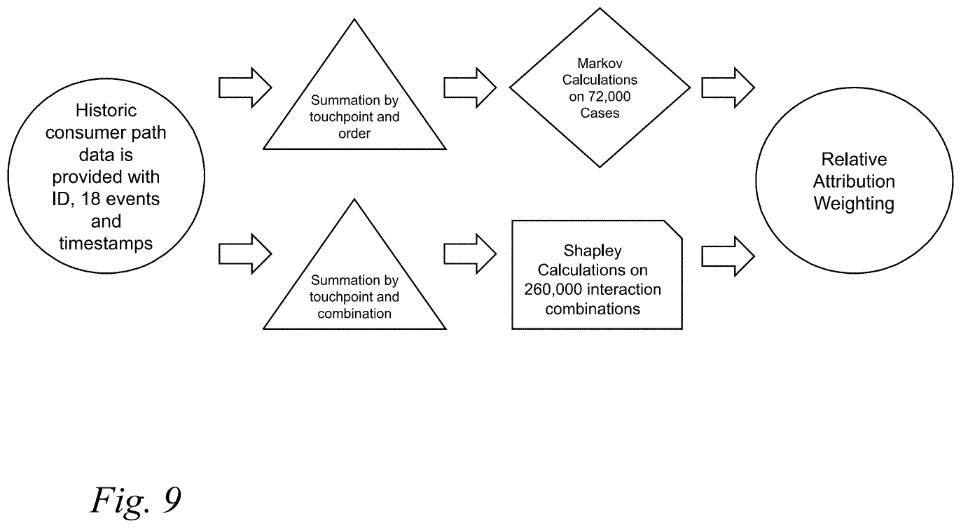

FIG. 9 is a comparative block diagram illustrating the differences between the present invention and systems based on the Shapely method that improves the efficiency of computer processing. Both models are comparatively illustrated in FIG. 9. Input data to both the Markov Removal Model and the Shapely model include an exemplary ID, 18 events and a time stamp. In response to the input data, the Markov Removal Model generates a summation by touchpoint and the order of the order of the touchpoints. In accordance with the present invention, the Markov model can generate calculations on 72,000 cases, for example, and provide relative attribution weighting. In response to the same input data, the Shapely model generates a summation by touchpoint and combination and would need to generate calculations on 260,000 interaction combinations; not computationally feasible with the Shapely mode.

Being that Shapley attribution is a game theory-based approach it is limited in its scope of use. The Shapley Value is based off the concept of a coalitional game is defined as: There is a set N (of n players) and a function where if S is a coalition of players, then the worth of coalition is defined as the total expected sum of payoffs the members of can obtain by cooperation. The Shapely approach is limited by the number of channels. Since every combination of touch points and interventions must have a distinct Shapley value, combinations of greater than fifteen touchpoints are untenable. and most importantly the Markov based transition matrix approach leads to a reduction in both training and scoring process time.

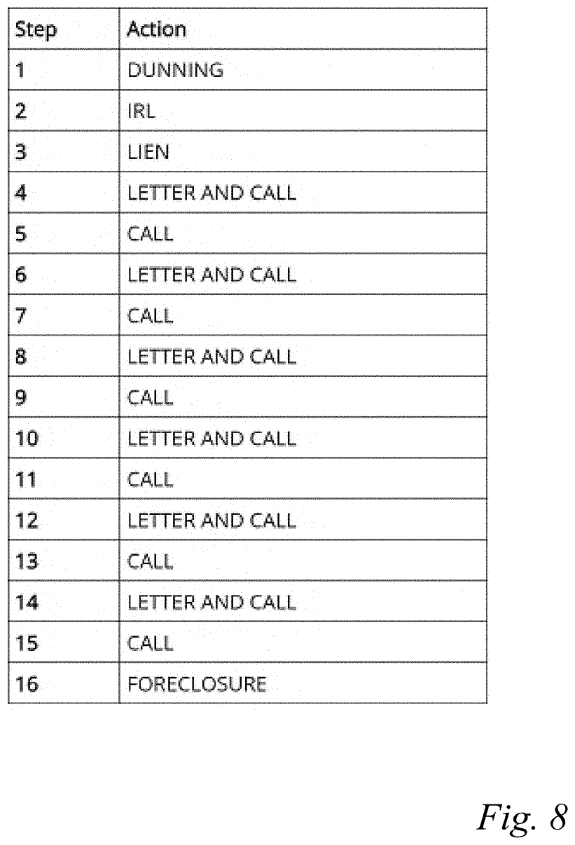

The present invention is not so limited. For example, with reference to FIG. 8, an exemplary sixteen channels or debtor states are shown for use with the present invention. These exemplary channels include, a dunning letter, IRL (real life interventions), lien, a letter & call, a call, a letter and call, a letter and call, a call, a letter & call, a call, a letter & call, a call, a letter & call, a call, a letter & call, a call, and a foreclosure, leading to thousands of combinations.

By using the Markov Removal Model in accordance with the present invention, collection agencies not bound by the number of channels available to reach out to debtors. With the potential of micro-targeted communications within each channel, testing as few as two targeted communication scripts for the following communication channels (call, letter, call and letter, SMS, email) the number of touch points rises to eighteen and would mimic the processing seen in the aforementioned study making it unfeasible in terms of both processing time and the computational costs for the Shapely model.

The attribution industry has focused upon Shapley attribution due to its ease of calculation for most cases. When order and timing of events are ignored, the Shapley approach provides quick and easy insights for marketers who for the most part are still focused on last touch or siloed reporting. While the Shapley approach may seem to be an advancement of what marketers have used it the past, the limitations mentioned above reduce its impact.

The concept of the Markov chain was first introduced by Andrey Markov in the 1880. While Markov models have been used in energy prediction and several similar fields their use in the attribution space is mostly limited to academic exercises. The approach described herein is novel in its use of a specific aspect of the Markovian model and the transition matrix outlined above.

By taking the results of this Markov based transition matrix (FIG. 7), the maximum at each consumer state is determined, while using a decayed memory term (the nth exposure to a media combination is the value from the transition matrix (v) raised to the nth power (vn)).

Optimal Touchpoint [i]=Max [Tᵢ₋₁,Tᵢ] where T is the transition weight from a prior state Tᵢ₋₁ to the next state Tᵢ, and [Tᵢ₋₁,Tᵢ]=,[Tᵢ₋₁,Tᵢ]ⁿ and n=the number of times [Tᵢ₋₁,Tᵢ] has been utilized,

This is a new approach to deriving the optimal path that has not previously been applied to utilizing a transition matrix to create an optimal consumer communication either within the debt collection side or from the broad targeted marketing space.

During the development of the scoring process, ten thousand historic delinquent accounts with eleven consumer states (start, dunning letter, IRL, lien, call, letter, letter & call, lawsuit, foreclosure, payment, PIF). This process took one minute and twenty seconds using the Markov Removal Model described herein and one minute and thirty-six seconds using the industry standard Shapley approach. At the current level, this process there is a 30% reduction in the production time of the transition matrix using this approach as compared to industry standard Shapley method. When two new consumer states are added (start, dunning letter, IRL, lien, call, letter, letter & call, SMS, email, lawsuit, foreclosure, payment, PIF), the claimed process takes one minute and twenty seconds using the Markov approach and five minutes and sixteen seconds using the industry standard Shapley approach. time reduction jumps to 400% with the addition of two new consumer states.

This reduction in process time was illustrated by one of the inventors in the peer reviewed study: Prantner, Jonathan (2019, May 9). Multi-touch attribution: A case study in automotive media optimization. In the Applied Marketing Analytics, Volume 5, Issue 1. The study analyzed 420,000 consumers with 3.5 MM consumer interactions. The author illustrated that the Markov approach was preferred for the attribution. The second reason is that eighteen separate touch points were included in the analysis. Under the Shapley Value method this would create a 262,000 level of interaction which is computationally infeasible. The computation time required for processing using the Markov method spanned with 3.5 MM observations and eighteen touchpoints clocked in at forty-five minutes. The Shapley attribution method required three weeks of processing.

Obviously, many modifications and variations of the present invention are possible considering the above teachings. Thus, it is to be understood that, within the scope of the appended claims, the invention may be practiced otherwise than as specifically described above.

1. A system for providing collection strategies for collecting delinquent debts based upon an address and delinquent amount of a debtor, the system comprising:
a data store for storing debtor information relating to debtor assets, debtor financial profile, and debtor communication habits regarding said debtor;
a computer system, responsive to receiving said debtor information from the data store, programmed to:
determine a collection strategies from a plurality of predetermined collection strategies and an expected number of days to settlement by a debtor, based on debtor information from said data store for a selected debtor for collecting a delinquent debt based upon a predictive Markov Removal Model which provides improved processing time by said computer system; and
generate a report indicating collection strategies for collecting said delinquent debt and the expected number of days for settlement by said debtor.

2. The system as recited in claim 1, wherein said computer is further programmed to generate a report that scores an account and data profiles, along with a recommended collection path and expected debt settlement date.

3. The system as recited in claim 1, wherein said Markov Removal Model is based upon a plurality of delinquent debtor states.

4. The system as recited in claim 3, wherein said plurality of delinquent debtor states include two or more of the following states (start, dunning letter, in real life, lien, call, letter, letter and call, SMS. Email, lawsuit, foreclosure, payment in full).

5. The system as recited in claim 1, wherein said system can be accessed on an individual debtor basis.

6. The system as recited in claim 1, wherein said system can be accessed on a batch basis for a plurality of said debtors.

7. The system as recited in claim 6, wherein said access is by an address of said debtor.

8. The system as recited in claim 1, wherein said data store includes information on said debtors' assets, a financial profile of said debtor and the communication channels used by said debtor.

9. The system as recited in claim 1, wherein said system generates a recovery score based on one or more types of debt collection interventions.

10. The system as recited in claim 9, wherein said one or more types of debt collection interventions include proactive interventions.

11. The system as recited in claim 9, wherein said one or more types of debt collection interventions include filing a lien against property of said debtor.

12. The system as recited in claim 9, wherein said one or more types of debt collection interventions include filing a lawsuit against said debtor.

13. The system as recited in claim 9, wherein said one or more types of debt collection interventions include foreclosing on said debtor's property.

14. The system as recited in claim 9, wherein the number of days to settle said debt by way of the one or more interventions is generated.
